(19) United States
(12) Patent Application Publication
(10) Pub. No.: US 2020/0207253 A1
(43) Pub. Date: Jul. 2, 2020

(54) RECHARGEABLE HEADLAMPS

(71) Applicant: Stephen Monks, Vancouver, WA (US)

(72) Inventor: Stephen Monks, Vancouver, WA (US)

(21) Appl. No.: 16/237,330

(22) Filed: Dec. 31, 2018

(51) Int. Cl. B60Q 1/04; B60Q 1/00; B62J 6/02; B60Q 7/00; H01Q 1/32; B60R 16/03

(52) U.S. Cl. CPC B60Q 1/0483; B60Q 1/0088; B62J 6/02; B60R 16/03; B60Q 7/00; H01Q 1/3283; B60Q 1/0408

(57) ABSTRACT

A rechargeable bracket removable from a vehicle is presented. The rechargeable bracket has a power source coupled to the rechargeable bracket where the power source supplies power to the rechargeable bracket. The rechargeable bracket has a wiring apparatus and the wiring apparatus is coupled to the power source. A power storage apparatus is communicatively coupled to the wiring apparatus and is coupled to the power storage apparatus by a power storage connector. A lamp is coupled to the power storage apparatus and contained within the rechargeable bracket. An insertion apparatus is described as being coupled to the rechargeable bracket and securable to the vehicle. The rechargeable bracket further has a wireless communication apparatus which includes a wireless antenna. The wireless antenna being coupled to the wireless communication apparatus and sending and receiving signals from an external application. The external application may be executed on a smartphone or other computing device.

### FIELD OF THE INVENTION

This invention relates to vehicle headlamps. More particularly, it relates to rechargeable vehicle headlamps.

### BACKGROUND

Motorized vehicles with electrical systems for ancillary power are well known and well within the knowledge of one of skill in the art. For example, boats planes autos, trucks, etc. have electrical systems which utilize some engine power to charge an energy storage unit, e.g. a battery, which in turn provides power to the vehicle electrical system. This power may be used to start vehicles electrically, as well as to power radios, lighting, headlights and taillights, signals, etc.

Some vehicle electrical systems have no storage unit, but provide power directly to the vehicle electrical system when operating, e.g. by direct or dynamo type powering to power lighting.

Electrically operated devices are known which rely on battery or other storage unit to operate independently of “house current”, yet have chargers which recharge the device by plugging into a house current outlet. Some may be operated even as recharging is being done.

Bicycles are known to have battery operated headlights which conceivably could be removable, but these headlights are not on motorized vehicles, are not connected to a vehicle electrical system and are not rechargeable.

### BRIEF DESCRIPTION OF THE DRAWINGS

FIG. 1 is a view of a vehicle.

FIG. 2 is an illustrated view of an exemplary rechargeable bracket.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

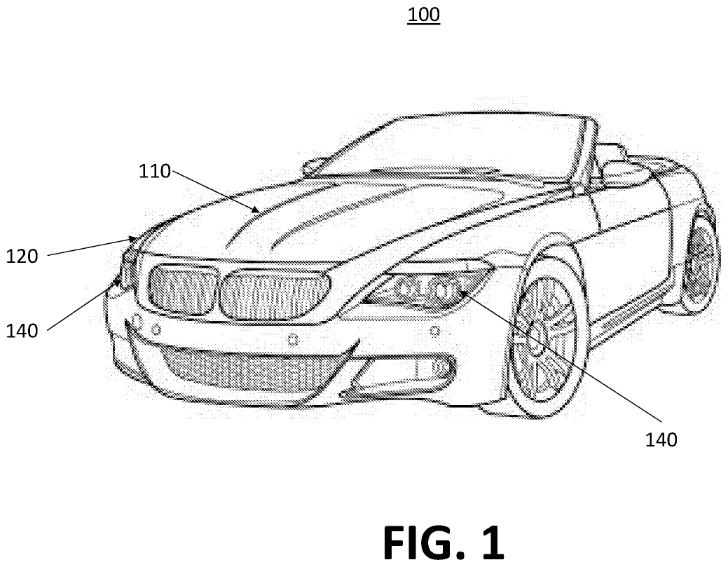

Referring to FIG. 1, an illustrated view of a vehicle 100 is presented. The vehicle 100 may be any kind of vehicle such as a car, pickup truck, box truck, work truck, etc. Further, the vehicle 100 is useful for moving people, cargo, pets, etc. a first location to a desired location quickly.

The vehicle 100 has a hood 110. The hood 100 is located on the front end of the vehicle 100. The hood 100 can be opened and closed such that one has the ability to access the engine, fluids, electrical system, etc. A battery 120 is located under the hood 110 of the vehicle 100. The battery 120 provides the power for the vehicle 100 to start the vehicle 100, to power the lamps 140 including the front lamps 140 and rear lamps with backup lamps (not shown).

The vehicle 100 historically has lamps 140 that are not removable unless completely being removed and replaced. The electrical system does not have a recharging capability for the lamps 140 if the lamps 140 would have a capacity to store electrical power.

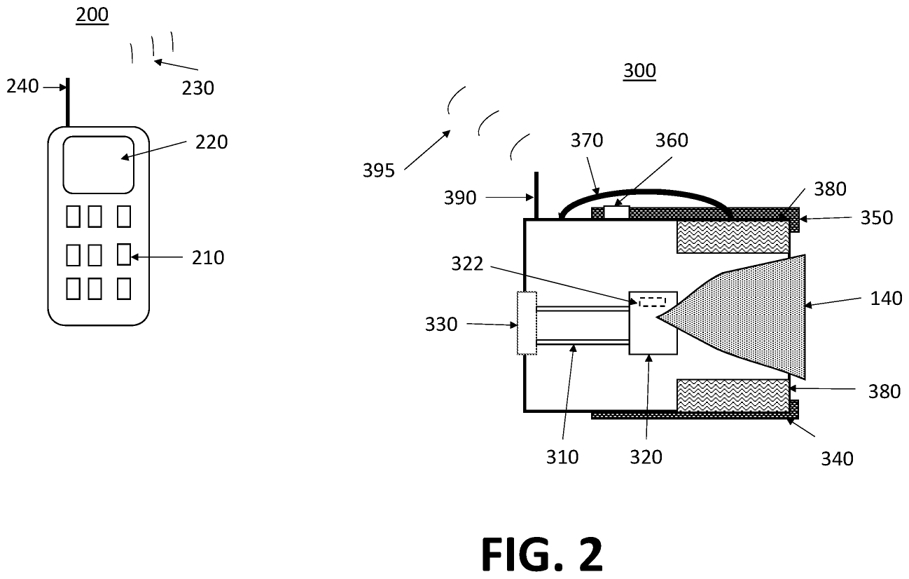

Moving now to FIG. 2, an illustrated view of an exemplary rechargeable bracket 300 is presented. The rechargeable bracket 300 is useful for charging the lamp 140 and allowing the lamp 140 to be mobile. The rechargeable bracket 140 fits into the slot for the lamps 140 of the vehicle 100 shown in FIG. 1.

The rechargeable bracket 300 is connectable to the battery 120 or other power source of the vehicle 100. The rechargeable bracket 300 has a wiring apparatus 310 and a power storage connector 320. The power storage connector 320 is coupled to the wiring apparatus 310 and allows the lamp 140 to be removably coupled such that the lamp 140 can be powered by the power storage connector 320. The power storage connector 320 has a power storage device 322 for storing electrical power.

The rechargeable bracket 300 is coupled to the vehicle 100 via a connector 330, when inserted into a lamp slot of the vehicle 100, such that the lamp receives signals and power from the vehicle and power is further stored in the power storage device 322.

The rechargeable bracket 300 receives a lamp 140. The lamp 140 is securely and communicably coupled to the power storage connector 320.

The rechargeable bracket 300 has insertion straps 340, 350. The insertion straps 340, 350 are preferably a steel material that is durable and flexible. The insertion straps 340, 350 are useful when inserting the rechargeable bracket 300 into the lamp socket of the vehicle 100 or when removing the rechargeable bracket 300 from the vehicle 100. The insertion straps 340, 350 are shown as steel straps but other methods for releasing or inserting the rechargeable bracket 300 into the vehicle 100 are also contemplated.

When the rechargeable bracket 300 is inserted into the vehicle 100, the insertion strap 350 presses against an on/off button 360. This insures that the lamp 140 is turned on while in the vehicle. When the rechargeable bracket 300 has been removed from the vehicle 100, the insertion strap 350 releases from the on/off button 360. Thus, the user can then control the power to the lamp 140 using the on/off button 360.

The rechargeable bracket 300 also has a handle 370, the handle 370 can be any type of handle that can be used to pick up the rechargeable bracket 300 to move it to a desirable location.

Alternatively and/or additionally, the rechargeable bracket 300 may have speakers 380. The speakers 380 are useful for hearing music, radio, etc.

To obtain music, radio, etc. to be heard through the speakers 380, the rechargeable bracket 300 is communicably coupled to a smart phone, radio, WiFi, etc. The rechargeable bracket 300 has a transmitter/receiver (not shown) which utilizes the antenna 390. The antenna 390 is capable of sending and receiving wireless signaling.

The antenna 390 broadcasts the signals or receives the signals via a signaling protocols in wireless signaling 395. The wireless signaling 395 can be direct, WiFi (802.11), WAN, Bluetooth, 5G, 3GPP, 3GPP2, AM/FM, etc.

A smart phone 200 may have an app 210 that can provide commands or data to the rechargeable bracket 300. The smart phone 200 determines the input of the user and displays the information on the screen 220 of the smart phone 200. The commands could include, but is not limited to, dimming or brightening the lighting, turning the light on or off, streaming music or radio over the antenna 390, sending alerts to the user, etc. Further, the information gathered may be useful for alerting when a condition such as low battery power is detected, etc.

The information is then transmitted to the rechargeable bracket 300 in wireless signaling 230 via an antenna 240 to the rechargeable bracket 300 where it is received on the antenna 390.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A rechargeable bracket removable from a vehicle, the rechargeable bracket comprising:
a power source coupled to the rechargeable bracket, the power source supplying power to the rechargeable bracket;
a wiring apparatus, the wiring apparatus coupled to the power source;
a power storage apparatus, the wiring apparatus communicatively coupled to the power storage apparatus by a power storage connector;
a lamp coupled to the power storage apparatus and contained within the rechargeable bracket;
an insertion apparatus, the insertion apparatus being coupled to the rechargeable bracket and securable to the vehicle;
a wireless communication apparatus, the wireless communication apparatus being coupled to the rechargeable bracket; and
a wireless antenna, the wireless antenna being coupled to the wireless communication apparatus and sending and receiving signals from an external application.

2. The rechargeable bracket removable from a vehicle of claim 1, wherein the power source is a battery.

3. The rechargeable bracket removable from a vehicle of claim 1, wherein the wireless communication apparatus being capable of encoding and decoding 3GPP signaling.

4. The rechargeable bracket removable from a vehicle of claim 1, wherein the wireless communication apparatus being capable of encoding and decoding Bluetooth signaling.

5. The rechargeable bracket removable from a vehicle of claim 1, wherein the rechargeable bracket is made of steel.

6. The rechargeable bracket removable from a vehicle of claim 5, wherein the external application runs on a computing device.

7. The rechargeable bracket removable from a vehicle of claim 6, wherein the computing device is a smartphone.

8. The rechargeable bracket removable from a vehicle of claim 1, wherein the rechargeable bracket having an on/off switch.

9. The rechargeable bracket removable from a vehicle of claim 1, wherein the rechargeable bracket having a handle.

10. The rechargeable bracket removable from a vehicle of claim 1, where the insertion apparatus is a strap and the strap securely coupled to the vehicle.

11. The rechargeable bracket removable from a vehicle of claim 1, wherein the lamp is a headlamp.
